(19) United States
(12) Patent Application Publication
(10) Pub. No.: US 2017/0083056 A1
(43) Pub. Date: Mar. 23, 2017

(54) DATA STORAGE UNIT SECURING DEVICE

(71) Applicant: HON HAI PRECISION INDUSTRY CO., LTD., New Taipei (TW)

(72) Inventor: CHIEH-CHEN CHEN, New Taipei (TW)

(21) Appl. No.: 14/879,889

(22) Filed: Oct. 9, 2015

(30) Foreign Application Priority Data
Sep. 23, 2015 (TW) 104131517

(51) Int. Cl. G06F 1/18; F16M 13/02; F16B 2/10

(52) U.S. Cl. CPC G06F 1/183; F16B 2/10; F16M 13/02

(57) ABSTRACT

A data storage unit securing device includes a bracket. The bracket includes a bottom plate, two securing plates, a pivot portion, and a first resilient member. The first resilient member includes two resilient rods and a latch rod. Each tail end of the first resilient rod is extended upwards. The first latch rod is connected between the tail end of the two first resilient rods. The first resilient member is rotatable towards the one of the securing plate to secure the first latch rod on the securing plate, and the first latch rod is configured to fasten a first data storage unit. The first resilient member is rotated towards the other securing plate to secure the first latch rod on the other securing plate, and the first latch rod is configured to fasten a second data storage unit which is thicker than the first data storage unit.

### FIELD

The subject matter herein generally relates to securing devices, and more particularly to a data storage unit securing device.

### BACKGROUND

With the development of science and technology, a computer needs to maintain different sizes of data storage units.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric, exploded view of a data storage unit securing device and two data storage units.

FIG. 2 is an isometric, assembled view of a data storage unit securing device and two first data storage units of FIG. 1.

FIG. 3 is a cross sectional view of FIG. 2, taken along a line III-III.

FIG. 4 is an isometric, assembled view of a data storage unit securing device and two second data storage units of FIG. 1

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

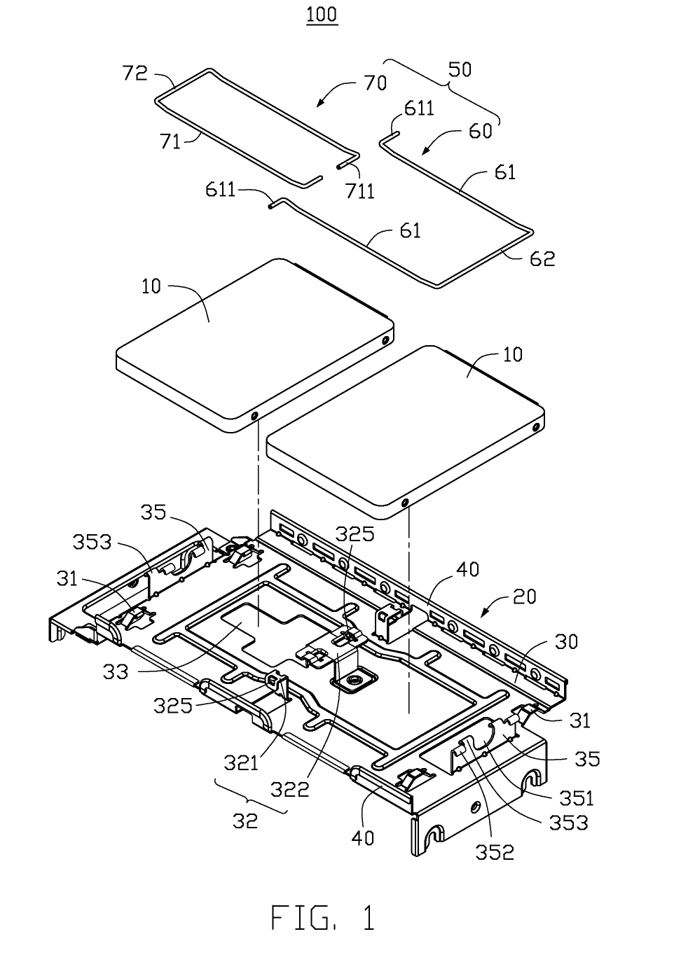

FIG. 1 illustrates one embodiment of a data storage unit securing device 100. The data storage unit securing device 100 is configured to fasten a plurality of data storage units 10 (two data storage units 10 are used as an example and are shown in each FIG.). The data storage unit securing device 100 includes a bracket 20 and a securing module 50 rotatably installed on the bracket 20.

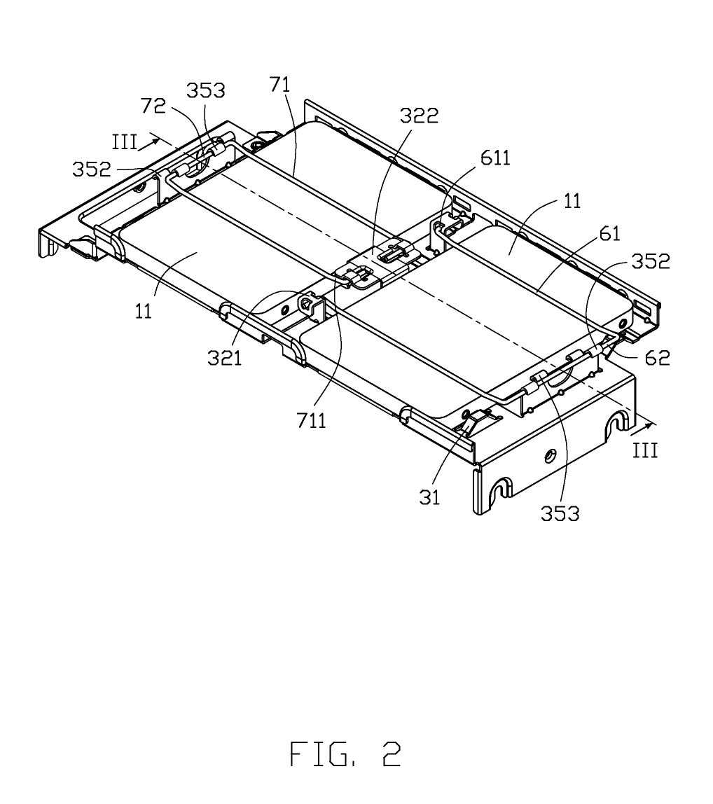

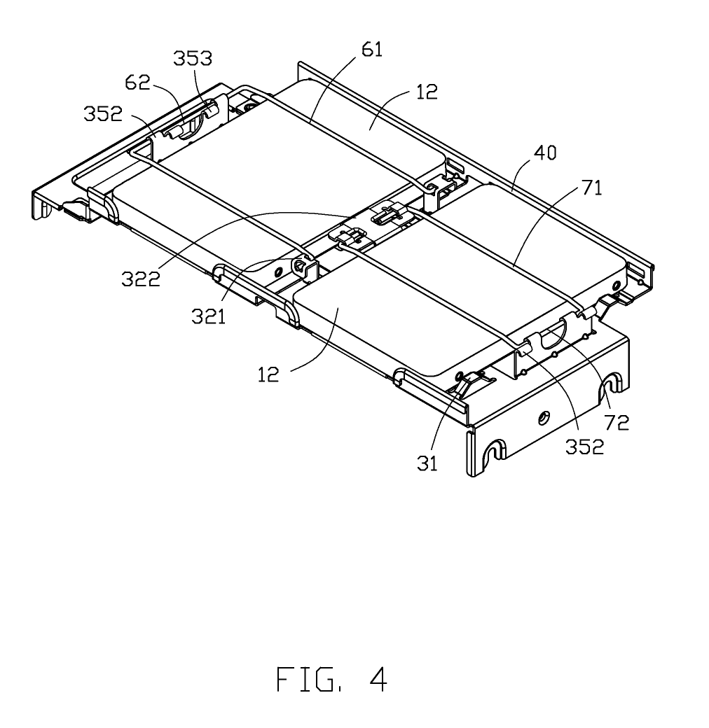

The plurality of data storage units 10 can include two first data storage units 11 (shown in FIG. 2) and two second data storage units 12 (shown in FIG. 4). The length and the width of the first data storage unit 11 are substantially equal to the length and the width of the second data storage unit 12. The thickness of the first data storage unit 11 is less than the thickness of the second data storage unit 12. In at least one embodiment, each data storage unit 10 is solid state drive (SSD).

The bracket 20 includes a bottom plate 30 and two side plates 40. The two side plates 40 are perpendicularly connected to two sides of the bottom plate 30. Each end of the bottom plate 30 is equipped with two stopper blocks 31. The middle portion of the bottom plate 30 is equipped with a pivot portion 32. The stopper blocks 31 of each end of the bottom plate 30 and the pivot portion 32 cooperatively define a receiving portion 33. The data storage unit 10 can be received in the receiving portion 33. The pivot portion 32 includes two first stopper plates 321 and a second stopper plate 322 located between the two first stopper plates 321. A pivot hole 325 is defined in each end of the second stopper plate 322 and each first stopper plate 321.

Each end of the bottom plate 30 is equipped with a securing plate 35 perpendicularly connected with the bottom plate 30. A notch 351 is defined in each end away from the bottom plate 30. The securing plate 30 is equipped with two first hooks 352 extending away from the pivot portion 32 and two second hooks 353 extending towards the pivot portion 32. The two second hooks 353 are located between the two first hooks 352.

The securing module 50 includes a first resilient member 60 and a second resilient member 70. The first resilient member 60 includes two substantially parallel first resilient rods 61. Each tail end of the first resilient rod 61 is extended upwards. A first latch rod 62 is connected between the tail end of the two first resilient rods 61. A first folding piece 611 extends from each end of the first resilient rod 61 away from the first latch rod 62. The first folding piece 611 is configured to be inserted into the pivot hole 325 of the two first stopper plates 321. A distance between the two first resilient rods 61 is greater than a distance between the pivot holes 325 of two first stopper plates 321.

The second resilient member 70 includes two substantially parallel second resilient rods 71. Each tail end of the second resilient rod 71 is extended upwards. A second latch rod 72 is connected between the tail end of the two second resilient rods 71. A second folding piece 711 extends from each end of the second resilient rod 71 away from the second latch rod 72. The second folding piece 711 is configured to be inserted into the two pivot holes 325 of the second stopper plate 322. A distance between the two second resilient rods 71 is less than a distance between the two pivot holes 325 of the second stopper plates 322. A distance between the two first resilient rods 61 is greater than a distance between the two pivot holes 325 of the second stopper plate 322.

When the data storage unit securing device 100 is assembled, as illustrated in FIG. 2, the two first resilient rods 61 are close to each other and elastically constricted. The two first folding pieces 611 are respectively inserted into the two pivot holes 325 of the two first stopper plates 321. The two first resilient rods 61 are elastically rebounded and the first folding pieces 611 are rotatably installed in the pivot holes 325. The two second resilient rods 71 are away from each other and elastically extended. The two second folding pieces 711 are respectively inserted into the two pivot holes 325 of the second stopper plate 322. The two second resilient rods 71 are elastically rebounded and the second folding pieces 711 are rotatably installed in the pivot holes 325.

In this state, the first resilient member 60 and the second resilient member 70 are located on two sides of the pivot portion 32. The first latch rod 62 and the second latch rod 72 are away from the bottom plate 30 compared with the first resilient rod 61 and the second elastic rod 71.

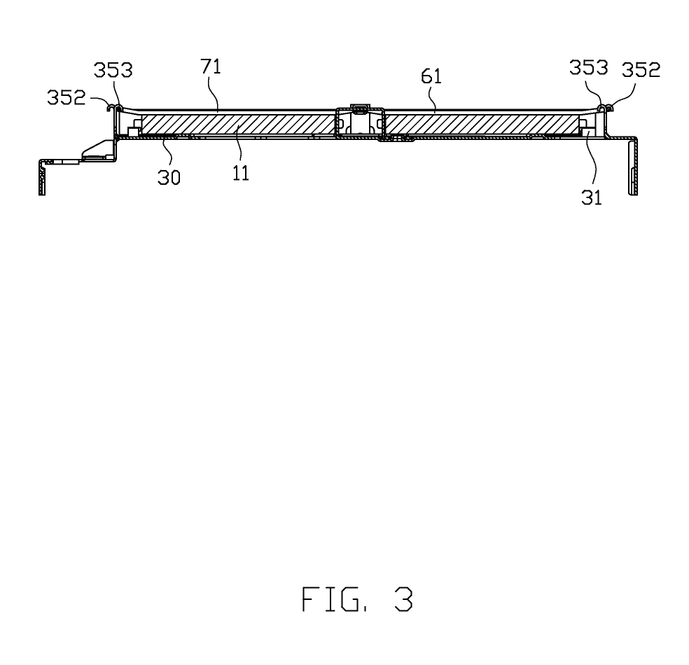

FIGS. 2 and 3 illustrate that the two first data storage units 11 are respectively located in the two receiving portions 33 of the bottom plate 30 when being secured. The stopper blocks 31, the pivot portion 32 and the two side plates 40 are respectively located around the first data storage unit 11. The first resilient member 60 is rotated and the first latch rod 62 is away from the bottom plate 30 compared with the first resilient rod 61. A distance between the first latch rod 62 and the bottom plate 30 is greater than a distance between the first resilient rod 61 and the bottom plate 30. The first latch rod 62 is fastened on the two first hooks 352 of one of the securing plates 35. The two first resilient rods 61 are resisted against the corresponding first data storage unit 11 to fasten the first data storage unit 11 in the bracket 20. The second resilient member 70 is rotated and the second latch rod 72 is away from the bottom plate 30 compared with the second resilient rod 71. A distance between the first second rod 72 and the bottom plate 30 is greater than a distance between the second resilient rod 71 and the bottom plate 30. The second latch rod 72 is fastened on the two second hooks 353 of the other securing plate 35. The two second resilient rods 71 are resisted against the other first data storage unit 11 to secure the other first data storage unit 11 in the bracket 20.

FIGS. 4 illustrates when the two second data storage units 12 need to be fastened, the two second data storage units 12 are respectively located in the two receiving portions 33 of the bottom plate 30. The stopper blocks 31, the pivot portion 32 and the two side plates 40 are respectively located around the second data storage unit 12. The first resilient member 60 is rotated and the first latch rod 62 is towards the bottom plate 30 compared with the first resilient rod 61. The first latch rod 62 is fastened on the first hooks 352 of one of the securing plates 35. The two first resilient rods 61 are resisted against the corresponding second data storage unit 12 to fasten the second data storage unit 12 in the bracket 20. The second resilient member 70 is rotated and the second latch rod 72 is near the bottom plate 30 compared with the second resilient rod 71. The second latch rod 72 is fastened on the second hooks 353 of the other securing plate 35. The two second resilient rods 71 are resisted against the other second data storage unit 12 to fasten the other second data storage unit 12 in the bracket 20.

In another embodiment, the first resilient member 60 can be retightened after being overturned. The first resilient member 60 and the second resilient member 70 can secure two data storage units 10 with different thicknesses at the same time.

In another embodiment, the bracket 20 can be only define one receiving portion 33, and the securing module 50 can only include one first resilient member 60 or one second resilient member 70. When two data storage units 10 of different thicknesses need to be fastened, the first resilient member 60 or the second resilient member 70 is struck and overturned, and then is fastened on the bracket 20 again. Then, the data storage unit securing device 100 can secure two data storage units 10 with different thickness on the bracket 20.

The embodiments shown and described above are only examples. Many details are often found in the art such as the other features of a data storage unit securing device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A data storage unit securing device comprising:
a bracket comprising a bottom plate, two securing plates, and a pivot portion located between the two securing plates;
a first resilient member rotatably installed on the pivot portion and comprising two parallel first resilient rods and a first latch rod;
wherein the tail end of each first resilient rod is extended upwards, the first latch rod is connected between the tail end of the two first resilient rods, the first resilient member is rotatable towards the one of the securing plate to secure the first latch rod on the securing plate, and the first latch rod is configured to fasten a first data storage unit; the first resilient member is rotated towards the other securing plate to secure the first latch rod on the other securing plate, a distance between the first latch rod and the bottom plate is less than a distance between the first resilient rod and the bottom plate, and the first latch rod is configured to fasten a second data storage unit which is thicker than the first data storage unit.

2. The data storage unit securing device of claim 1, wherein the data storage unit securing device further comprises a second resilient member rotatably installed on the pivot portion, the second resilient member comprises two parallel second resilient rods and a second latch rod, the tail end of each second resilient rod is extended upwards, the second latch rod is connected between the tail end of the two second resilient rods, the first latch rod and the second latch rod are configured to be respectively fastened on the two securing plates at the same time.

3. The data storage unit securing device of claim 2, wherein when the first latch rod and the second latch rod are respectively fastened on the two securing plates, the first latch rod and the second latch rod are away from or towards to the bottom plate compared with the first resilient rod and the second resilient rod.

4. The data storage unit securing device of claim 2, wherein when the first latch rod and the second latch rod are respectively fastened on the two securing plates, the first latch rod is away from towards the bottom compared with the first resilient rod and the second latch rod is towards to the bottom compared with the second resilient rod;
the first latch rod is f towards to the bottom compared with the first resilient rod and the second latch rod is away from the bottom compared with the second resilient rod.

5. The data storage unit securing device of claim 2, wherein a distance between the two first resilient rods is greater than a distance between the two second resilient rods.

6. The data storage unit securing device of claim 2, wherein each securing plate is equipped with two second hooks extending towards the pivot portion, the second latch rod is configured to be fastened on the second hooks.

7. The data storage unit securing device of claim 2, wherein the bracket further comprises two side plates, the two side plates are perpendicularly connected with the two sides of the bottom plate, the two side plates, the two securing plates and the pivot portion are located around the data storage unit to prevent the data storage unit waggling.

8. The data storage unit securing device of claim 1, wherein the pivot portion comprises two first stopper plates, each stopper plates defines a pivot hole, the end of each first resilient rod comprises a first folding piece, the folding piece is configured to be inserted into the pivot rod to rotatably install the first resilient member on the pivot portion.

9. The data storage unit securing device of claim 1, wherein each securing plate is equipped with two first hooks extended away from the pivot portion, the first latch rod is configured to be fastened on the first hooks.

10. A data storage unit securing device comprising:
a bracket, comprising a bottom plate, a securing plate and a pivot portion;
a first resilient member rotatably installed on the pivot portion, comprising two parallel first resilient rods and a first latch rod;
wherein the tail end of each first resilient rod is extended upwards, the first latch rod is connected between the tail end of the two first resilient rods, the first resilient member is rotated towards the securing plate to secure the first latch rod on the securing plate, a distance between the first latch rod and the bottom plate is greater than a distance between the first resilient rod and the bottom plate, and the first latch rod is configured to fasten a first data storage unit; the first resilient member is turnover to be rotatably installed on the pivot portion, the first resilient member is rotated towards the securing plate to secure the first latch rod on the securing plate, a distance between the first latch rod and the bottom plate is less than a distance between the first resilient rod and the bottom plate, and the first latch rod is configured to fasten a second data storage unit which is thicker than the first data storage unit.

11. The data storage unit securing device of claim 10, wherein the data storage unit securing device further comprises two securing plates located two sides of the pivot portion, the first resilient member is configured to be rotated towards the two securing plates to fasten the first data storage unit or a second data storage unit.

12. The data storage unit securing device of claim 11, wherein the data storage unit securing device further comprises a second resilient member rotatably installed on the pivot portion, the second resilient member comprises two parallel second resilient rods and a second latch rod, the tail end of each second resilient rod is extended upwards, the second latch rod is connected between the tail end of the two second resilient rods, the first latch rod and the second latch rod are configured to be respectively fastened on the two securing plates at the same time.

13. The data storage unit securing device of claim 12, wherein when the first latch rod and the second latch rod are respectively fastened on the two securing plates, the first latch rod is away from towards the bottom compared with the first resilient rod and the second latch rod is towards to the bottom compared with the second resilient rod; the first latch rod is f towards to the bottom compared with the first resilient rod and the second latch rod is away from the bottom compared with the second resilient rod.

14. The data storage unit securing device of claim 12, wherein when the first latch rod and the second latch rod are respectively fastened on the two securing plates, the first latch rod is away from or towards to the bottom compared with the first resilient rod and the second latch rod is towards or away from the bottom compared with the second resilient rod.

15. The data storage unit securing device of claim 12, wherein a distance between the two first resilient rods is greater than a distance between the two second resilient rods.

16. The data storage unit securing device of claim 12, wherein each securing plate is equipped with two second hooks extended towards the pivot portion, the second latch rod is configured to be fastened on the second hook.

17. The data storage unit securing device of claim 12, wherein the bracket further comprises two side plates, the two side plates are perpendicularly connected with the two sides of the bottom plate, the two side plates, the two securing plates and the pivot portion are located around the data storage unit to prevent the data storage unit waggling.

18. The data storage unit securing device of claim 11, wherein the pivot portion comprises two first stopper plates, each stopper plates defines a pivot hole, the end of each first resilient rod comprises a first folding piece, the folding piece is configured to be inserted into the pivot rod to rotatably install the first resilient member on the pivot portion.

19. The data storage unit securing device of claim 11, wherein each securing plate is equipped with two first hooks extended away from the pivot portion, the first latch rod is configured to be fastened on the first hook.

20. A data storage unit securing device comprising:
a bracket comprising:
a bottom plate,
two securing plates, and
a pivot portion located between the two securing plates;
a first resilient member rotatably installed on the pivot portion and comprising:
two parallel first resilient rods, each of the two parallel first resilient rods having a tail end that extends upwards, and
a first latch rod connected between the tail end of the two first resilient rods and is configured to fasten to a first data storage unit;
wherein the first resilient member is configured to rotate towards one of the two securing plates to secure the first latch rod to the one securing plate and to rotate towards the other one of the two securing plates to secure the first latch rod on the other securing plate;
wherein a distance between the first latch rod and the bottom plate is greater than a distance between the first resilient rod and the bottom plate and a distance between the first latch rod and the bottom plate is less than a distance between the first resilient rod and the bottom plate;
wherein the first latch rod is configured to fasten a second data storage unit, which has a thickness that is greater than a thickness of the first storage unit.
